(19) United States
(12) Patent Application Publication
(10) Pub. No.: US 2007/0292465 A1
(43) Pub. Date: Dec. 20, 2007

(54) Eutectic biocide compositions and formulations

(75) Inventors: Michael Parkin, Augst/BL (CH); Uwe Falk, Bruchkoebel (DE); Cezanne Vielkanowitz, Charlotte, NC (US)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant International, Ltd.

(21) Appl. No.: 11/454,287

(22) Filed: Jun. 16, 2006

(51) Int. Cl. A01N 31/08; A01N 25/00

(52) U.S. Cl. 424/405; 514/737; 514/736

(57) ABSTRACT

Binary or greater mixtures of biocides which exist in the form of eutectic blends which range from damp blends to liquid blends are described. Mixtures of phenolic biocides are preferred. The biocides are useful in the formulation of disinfectant compositions for industrial and domestic use.

The present invention relates to biocide formulations, in particular to combinations or compositions of biocides and especially to combinations or compositions including at least one phenolic biocide, the physical state of which combinations or compositions is other than dry powder or flake.

Biocides, including phenolic biocides, are well known and widely used in the art in a wide range of industrial and domestic disinfectant and cleaning formulations, paint produces and like.

It is common procedure for biocides such as phenolic biocides to be supplied in solid form, which is their normal physical state at room temperature and below. Generally, such biocides have a melting point higher than room temperature and so are provided in solid dry particulate form, e.g. powder or flake form.

In practice, the steps required to produce a desired product formulation, such as a disinfectant formulation, from a solid biocide must include adding the solid biocide (e.g. a phenolic biocide) to other formulation ingredients, such as water, colourants, fragrances, viscosity modifiers, surfactants, solvents and such like.

Handling biocides, such as phenolic biocides, which are in dry particulate form can be inconvenient and may present health and safety issues for both the handling and the storage. For example, dust from the biocides may be an irritant if inhaled or brought into contact with the skin or eyes or mucous membranes, so that special handling techniques and protective clothing and masks are required. Potential or actual dust contamination to both plant machinery and personnel can require substantial safety checks and procedures to ensure that the level of biocide is kept at a safe working level. Any such contamination can result in a costly program of decontamination and an increased maintenance programme for plant machinery. In particular, dust can get into machinery and impair its performance.

In addition to these safety issues, the release of biocide dust to the local atmosphere can result in the loss of a significant amounts of the biocide as biocide waste, for example where deposited dust is simply washed away during decontamination or where it escapes in the air, e.g. through a ventilation system. This is not only wasteful and uneconomic, but also causes an environmental issue of disposal or, in the case of air-borne loss, of control, of such waste.

The transport and transfer of dry particulate biocides on an industrial scale can also pose problems due to the health, safety and cost issues described above. A further significant problem encountered by a plant using dry particulate biocides is the measuring-out, dispensing and internal transfer of such dry particulate material. It is difficult during such activities to control air-borne escape of dry particulate biocides and consequently specialist equipment, e.g. for weighing and safe transfer, is required.

Where a product formulation contains more than one biocide, the health and safety issues associated therewith increase with each additional biocide, since each component biocide must be separately measured, dispensed and transferred to the product formulation and each processing stage may be required to undergo a decontamination step from time to time. The additional exposure to multiple biocides will thus inevitably lead to increased potential release of the biocide into the atmosphere, increased probability of contact with personnel and increased probability of waste and spillage. This added complication causes greater expense associated with decontamination procedures and the like. This financial and logistical burden to provide extra support for the additional complexity of the handling and storage discourages manufacturers to use more than one biocide in a product formulation.

The present invention seeks to provide an alternative route to providing biocides (preferably including at least one phenolic biocide) for use in biocidal products or formulations, in particular in disinfectant formulations, cleaning formulations, or in other product formulations which require the incorporation of a biocide (for example as a preservative), which route minimises or overcomes the problems associated with the dry particulate products of the prior art.

The present inventors have appreciated that, in suitable mixtures, upon blending two or more solid biocides, the biocides may interact with one another in a manner which affects their physical state. In particular, the properties of blends of two or more biocides may tend towards, and in ideal cases may achieve, a eutectic blend. Thus, in such blends of biocides, the resulting composition is no longer in dry powder or dry flake from and many of the problems highlighted above are obviated.

The properties or characteristics of a biocide eutectic blend according to the invention are defined by the absence of dry powder or flake (which powder or flake can be difficult to handle, as described above) and will normally range from soft, damp or waxy solids, to crystal solutions, suspensions, possible containing crystalline solids, typically suspensions of soft or waxy solids, viscous liquids and free flowing liquids. Of course suspensions, liquids, liquid-crystal mixtures, and in particular free flowing liquids, are preferred. Thus, as used herein, the term eutectic blend is not restricted to an optimal blend of two or more components, which exhibits the lowest freeze point, but is a combination of two or more components which has a lower freeze point than at least one of the individual components.

Combinations of biocides with properties within this range are hereinafter referred to as “damp blends or liquid blends or liquid crystal blends”, it being understood that “damp” in this context is not primarily attributable to the presence (by addition) of water. It will be understood that the compositions of the present invention in which binary or greater mixtures of biocides exist in liquid form or forms in which liquid is present such as suspensions or damp solids are distinct from aqueous or other solutions of the biocides.

In one aspect, the compositions of the present invention are comprised substantially entirely, or consist essentially of the biocides and, preferably, do not include added water or other solvents. In some cases, minor amounts (up to 5 wt % in total, preferably not more than 2%, more especially not more than 1%) of formulating additives may be included in some compositions according to the invention, for example to increase long term stability or to provide a desired colour. Typical formulating additives may include water, alcohol, colourants, fragrances, viscosity modifiers, surfactants (for example to aid dispersion of a suspension), solvents, and mixtures thereof.

For a particular application, the amount of choice, or an effective amount may be determined by routine testing of various amounts prior to treatment of the entire affected substrate or system.

The blends of the present invention may be used in Usual Disinfecting Hard Surface Cleaner, for example. As such, the blends of the present invention may be used in conjunction with one or more of anionic surfactants (HOSTAPUR SAS, LAS, for example); non ionic surfactants (GENAPOL UD series, nonyl phenyl ethoxylates, for example); solvents (butile cellosolve, isopropanol, propylene glycol, for example); collating agents (EDTA, for example); abrasives (sodium metalsilicate, for example); disinfecting component (phenolics, quats, for example). (HOSTAPUR and GENAPOL are trademarks of Clariant Corp., Charlotte, N.C.).

The table below provide an example of formulations included in the scope of the present invention:

| | Example | Percentage | Example |
|---|---|---|---|
| Additive | Ingredient | Weight Range | Percentage |
| Active Ingredient | BCP | 0–15% | 5.0% |
| Active Ingredient | OPP | 0–6% | 4.25% |
| Active Ingredient | PTAP | 0–3% | 1.25% |
| Solvent | IPA | 0–60% | 19.94% |
| | Water | | 50% |
| Detergent | ULTRAWET KX | 0–25% | 7.0% |
| | SXS 40 | | 9.0% |
| | DOWFAX 282 | | 2.0% |
| | DOWFAX 2AI | | 20% |
| Perfume | — | 0–12% | 9.0% |
| Chelating Agent | Na-EDTA | 0–5% | 3.0% |
| Colour stabilizer | Sodium Sulfite | 0–1% | 0.5% |

The biocide eutectic blends may therefore be used as intermediates in the formation of household products such as disinfectants and paints, for example. To this end, the biocide eutectic blends of the present invention may comprise from 0.1 ppm to 50 wt % of the final product.

By way of example, an effective amount of the biocide eutectic blend as described herein that is used on a substrate may range from about 0.0001% to about 15% (w/w).

Each biocide component of a biocide eutectic blend may be independently present in an amount of 0, 1, 2, 3, 4, 5, 6, 7, 8 9, 10, 11, 12, 13, 14 or 15 wt % of the total formulation, preferably prior to dilution. In some cases, any one biocide may not be present in an amount of more than 10%, typically 5%.

With aqueous, dilute, systems, an effective amount may range from about 0.5 to about 5000 parts per million, more preferably from about 5 to about 1000 parts per million of the aqueous system, and most preferably from, about 10 to about 25 parts per million, and in some cases as low as 0.5 ppm.

The biocide eutectic blends of the present invention may be components of a concentrate, which may have higher amounts of the biocide therein, for example 0.1 to 20%.

The present invention therefore not only provides a way of introducing a plurality of biocides into the disinfectant formulations, cleaning formulations and the like while minimising or obviating the existing safety issues but also provides a damp blend of liquid blend composition to which other solid or liquid ingredients may be added, or conversely, provides a damp blend or liquid blend composition that can be added to other solid or liquid ingredients. Furthermore, the handling and measuring of such a damp blend or liquid blend composition is far more desirable on an industrial scale than the handling and measuring of a dry particulate material.

The provision of at least two biocides already substantially mixed in a form other than any particulate, e.g. in the form of a damp blend or liquid blend, e.g. in substantially liquid form, means that only one measurement needs to be performed for the incorporation of a plurality of biocides in to a final formulation such as a disinfectant product, whereas in order to do this prior to the present invention, both (or more) solids would have had to be measured and handled separately. Furthermore, it is advantageous for the manufacturer of a product, such as a disinfectant or cleaning formulation, which requires the addition of biocides to be provided (by the biocide manufacturer) with a biocide composition which includes the desired biocides in the correct relative amounts. The product manufacturer thus needs only to carry out one measurement or metering operation to add the required biocides to his formulation. Errors in measurement of the required amounts of the respective biocides are also minimised.

It will be appreciated that it is not necessary for the biocide eutectic blend compositions of the invention to be the optimum eutectic mixture (although the optimum eutectic mixture is preferred since it will provide the lowest freezing point). However, it is necessary for the purposes of the present invention only that the binary, ternary, quaternary or greater composition provides a sufficient freezing point depression so that the composition is no longer in dry particulate form, that is, so that the composition is a damp blend or liquid blend, as discussed above, at its normal temperatures of handling and use, for example 0 to 40° C., typically 20 to 40° C. The eutectic blend compositions of the present invention preferably maintain their physical characteristics during storage and during winter conditions.

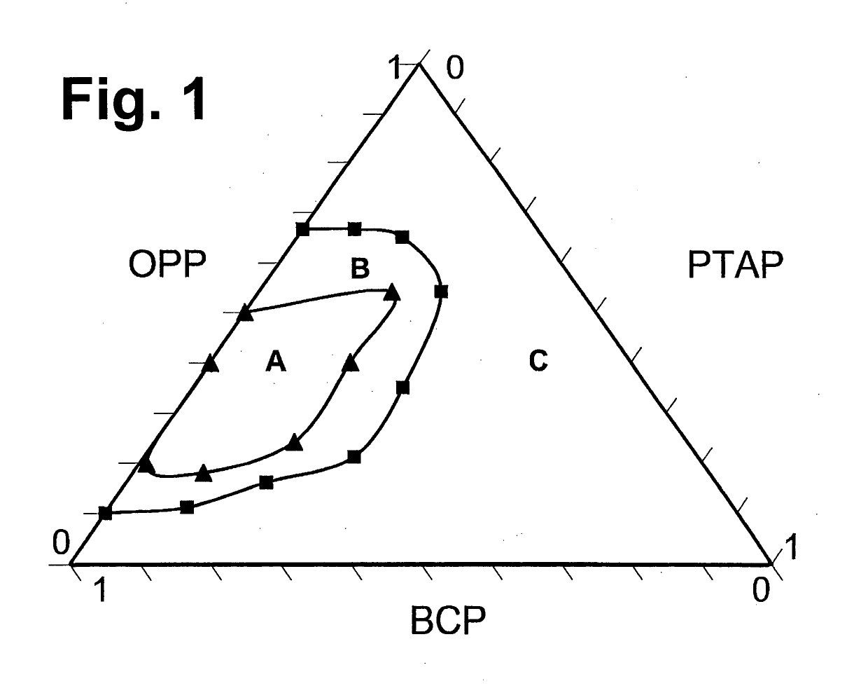

FIG. 1 illustrates the physical states of a ternary mixture of biocides are selected from o-benzyl p-chlorophenol(BCP), p-tertiary amyl phenol (PTAP, 4-(1,1-dimethylpropyl)phenol, and o-phenyl phenol (OPP, 2-phenylphenol), pentachlorophenol (PCP).

By means of the present invention the problems associated with the release of dry particulate biocide materials to atmosphere are largely or entirely obviated. The viscous or free flowing liquids according to the invention are most advantageous because the measurement, dispensing and mixing of these liquids into final products formulations (such as disinfectants) is facilitated to the greatest extent. However, suspensions and even the soft, damp or waxy solids are advantageous since release of the biocide materials to atmosphere is no longer a problem and handling of the materials becomes much easier.

It will be understood that the exact physical characteristics of the blend of two or more biocides will be dependent on which biocides are mixed, how many are mixed and in what quantities they are mixed (both overall and with respect to one another). Thus the physical states encompassed by the present invention include any state which is not a dry powder or flake and within the range from perceptible cohesion between biocides (e.g. waxy solid) to true eutectic liquids.

Whereas it is preferred to provide a homogenous mixture or blend from mixing two or more biocides, it will be understood that heterogeneous dispersions are contemplated, which may exist in any of the physical states (e.g. small particles or crystals dispersed in a waxy solid or a suspension of particles in a liquid) herein described.

In some blends of the present invention, the mixture is present as a liquid-crystal mixture. In such mixtures, the blend is still preferably free flowing, or at least not in a dry powder or flake form, which may be easily airborne, for example. The crystals in a crystal-liquid mixture are preferably easily broken and/or micronised and/or dispersed within the liquid. In a particular class of blends, which comprise liquid and crystals, the crystals are long and thin.

In a particular class of blends of the present invention, the liquid-crystal solutions contain at least 50% liquid v/v. In a further preferred class of blends of the present invention, a liquid-crystal solution contains at least 75% liquid v/v. In yet another class of blends of the present invention, less than 20% of the blend is in crystalline form.

As it will be appreciated, the term “crystalline” may be considered a sub-class of the term “solid”. Therefore a “crystalline-liquid mixture” may have the physical characteristics associated with a solid in solution and may also include blends having the physical properties of a suspension and the like, for example.

As is well known, the melting point of a pure substance is normally sharp and definite and hence valuable for the purposes of identification of the substance. However, this melting point can be considerably influenced by the presence of other substances; and, for example, this occurs commonly where the “other substance” is an impurity. The depression of melting point arising from the presence of impurities is, in general terms, well known. The inventors of the present invention have appreciated that this characteristic can be exploited in order to overcome the prior art problems discussed above. By means of the present invention combinations of biocides exist in fluid, suspension or at least “non-dry” form because they are capable of forming at least in part a mixture where the freezing point/melting point is lower than the freezing point/melting point of the individual biocides, and ideally of forming a eutectic liquid.

The depression of the melting point which leads to the formation of a eutectic blend is believed to be dependent upon the level of solubility (or interactions or cohesion) of one component of the system within another. For example, in a binary system which comprises first and second substances, the depression of the melting point of the blend compared with the melting point of the second substance is dependent upon the degree of solvation with the first substance. In the case of a binary biocide system, the depression of the melting point is dependent upon the degree of solvation of a second biocide with a first biocide (the first biocide acting as a solvent). Therefore, for a binary blend, if two different second substances have equal solubility in the first substance, the depression in melting point of the respectively formed binary blends will be equal irrespective of the melting points of the second substances. Hence, the melting point reduction and ratios of the first and second substances required to achieve such a reduction vary between second substances as a result of their solubility in the first substance.

The effect of the addition of a third substance follows substantially the same principles as the addition of the second substance. However, the solubility of the third substance within both of the initial substances now influences the final solubility and concomitant depression of the freezing point. It is thus preferred that the third biocide is substantially equally soluble in both of the initial substances.

In the present invention, the required extent of the solubility of respective biocides with one another thus depends on how much the melting point needs to be depressed in order to provide the desired physical characteristics of the blend. If a blend is required to be in liquid form at room temperature, then the biocides will be required to have good solubility with one another. If however, only a waxy solid or a liquid with suspended particles is required, the requirement for good solubility between the biocide components is not as rigorous.

Ideally, the biocides used for forming the compositions of the present invention have relatively low melting points. For example some blends may have a melting point of less than 200° C., typically less than 150° C. In one particular class of blends the mixture has a melting point of below 120° C., typically below 100° C. In a further class of blends of the present invention the blend has a melting point of less than 75° C., for example between 60 and 80° C.

In one particular class of blend of the present invention, the blend has an overall lower melting point than the average melting point of its component parts (i.e. the biocides), for example a melting point lower than at least one of the components, typically lower than at least two of the components. In a particular class of compounds the melting point of the blend is less than the average melting point of the all of individual biocides making up the blend.

Generally for a given combination of two or more substances, there will naturally be an optimum ratio which has the lowest melting point. However, the present invention encompasses a range of ratios at which the aforementioned damp blends or liquid blends may be formed at around room temperature, by combining the dry particulate forms of the individual biocides.

According to a first aspect of the present invention there is provided a eutectic blend composition consisting essentially of a mixture of two or more biocides and not more than 5% in total of formulating additives wherein the composition is in the form of a damp blend or liquid blend (as herein defined) at temperatures within the range of 0° C. to 50° C.

In some preferred embodiments, the composition consists of three or more biocides. Preferably at least one of the biocides is a phenolic biocide. In some preferred embodiments every one of the biocides is a phenolic biocide.

In preferred embodiments the biocides are selected from o-benzyl p-chlorophenol (BCP), p-tertiary amyl phenol (PTAP, 4-(1,1-dimethylpropyl)phenol), o-phenyl phenol (OPP, 2-phenylphenol), pentachlorophenol (PCP), hexachlorophenol (aka hexachlorophene, 3,4,6-trichloro-2-[(2,3,5-trichloro-6-hydroxy-phenyl)methyl]phenol, bromophene (2,4-dibromo-6-(3,5-dibromo-2-hydroxy-phenyl)phenol), Triclosan, isothiazolinone (5-chloro-2-methyl-isothiazol-3-one, bromonitropropanediol, hexahydro-1 3,5-tris (hydroxyethyl)-s-triazine, sodium pyridine thiol-1-oxide, 3-iodo-2-propynyl butyl carbamate, methylene-bis-morpholine, benzisothiazolinone, n-octyl isothiazolinone, para chloro meta cresol (PCMC, 4-chloro-3-methyl-phenol), sodium salt of para chloro meta cresol (NaPC), para chloro meta xylenol ((PCMX), 4-Chloro-3,5-dimethylphenol)), dichloro meta xylenol (DCMX, 2,4-dichloro-3,5-dimethyl-phenol), sodium salt of ortho phenyl phenol (SOPP), sodium pyrithione, hexahydrotriazine, Trichlocarban (TCC, (4-chlorophenyl)amino-(3,4-dichlorophenyl)amino-methanone), 2-(thiocyanomethylthio) benzothiazole, 1,3,5-triethylhexahydro-1,3,5-triazine, chlor-methyl isothiazolinones, Bronopol (2-bromo-2-nitropropane-1,3-diol), NIPOCIDE FC(1,6-dihydroxy-2,5-dioxahexane) and sodium pyrithione.

Preferably, where present, the formulating additives are comprised one or more of water, alcohol, colorants, fragrances, viscosity modifiers, surfactants, solvents, and mixtures thereof.

In some preferred forms the composition comprises a liquid component consisting of a biocide mixture and at least one solid component consisting of one or more biocides. In one preferred form the composition of the invention is in the form of a suspension. In particularly preferred forms of the invention the biocides are present in the eutectic composition.

In one preferred composition of the invention the biocides are o-benzyl p-chlorophenol(BCP), p-tertiary amyl phenol(PTAP) and o-phenyl phenol(OPP). Applicant's surprisingly discovered that a liquid eutectic blend of these three components results when the biocide composition consists essentially of about 30 to 60 wt-% BCP, from about 28 to 54 wt-% OPP, and at least about 12 wt-% PTAP. Applicant further discovered that a suspended eutectic blend resulted when the BCP amount was between about 33 and about 85 wt-%, the OPP amount was about 10 to 70 wt-% and the PTAP amount was less than about 30 wt-%.

In another preferred composition of the invention the composition comprises not more than 66.5% o-benzyl p-chlorophenol, not more than 28.5% o-phenyl phenol and at least 5% p-tertiary amyl phenol

According to a second aspect of the invention there is provided a method of preparing a disinfectant or cleaning formulation including the step of adding a composition as defined in the first aspect of the invention.

According to a third aspect of the invention there is provided a disinfectant or cleaning formulation when prepared by the method of the second aspect of the invention.

Thus, the present invention provides a composition comprising a mixture of two or more biocides wherein at temperatures within the range of from about 0° C. to about 50° C., typically 5° C. to 40° C., such as 25 to 40° C., for example, the physical state of composition is other than a dry powder or dry flake, and more especially wherein the physical state of the composition is a damp blend or liquid blend. The damp blends or liquid blends fall within the range of from soft, damp or waxy solids, to crystal solutions to suspensions of soft or waxy solids, to viscous liquids and to free flowing liquids. Preferably at least one of the biocides is a phenolic biocide. In especially preferred compositions, both or all of the biocides are phenolic biocides.

A suspension may be defined in general terms as a solid dispersed in a liquid. Typically, a suspension will eventually separate out into solid and liquid layers upon standing. Therefore the degree of suspension, i.e. the amount of solid suspended in a liquid can be measured by determining the respective liquid and solid layers upon standing. In preferred forms of the present invention, where the composition is a suspension, the solid component of the suspension amounts to no more than 50% of the total volume of solid and liquid. Preferably the solid amounts to no more than 40% of the total volume, for example less than 30%.

Particularly preferred suspension of the present invention remain dispersed at temperatures of use of between 0° C. and 50° C. for at least 1 month, e.g. at least 3 months. In other words, the suspensions of the present invention are preferably stable suspensions.

In one particular class of blends of the present invention the eutectic blends are liquid or substantially liquid at temperatures of use, for example at room temperature. In this class, the eutectic blends may be stored at lower temperatures in the solid or partial-solid form and return to a substantially liquid form at room temperature. This may be conducted, for example, by warming to 0 to 20° C. Some blends of the present invention may be stored in solid form and may return to a liquid-crystal mixture or waxy solid upon warming to 0 to 20° C.

The compositions of the present invention may also be in the form of a waxy solid. The waxy solid may be defined by its density. In particular, the waxy solids of the present invention may be defined by measuring relative deformations under controlled conditions. If the waxy solid does not retain the deformation, the blend is less solid. A qualitative measure if this property was obtained by forming a depression in the blend with a probe. If the depression disappeared after a reasonable interval of time, the blend was said to be a waxy solid.

A waxy solid may have the characteristics of a dispersed mixture. In other words, like a liquid-crystal mixture, the waxy solid may have crystals dispersed within the waxy solid thus forming a waxy-solid-crystal matrix.

In preferred embodiments preferably the composition has said physical state (that is the damp blend or liquid blend) at least within the temperature range of from about −25° C. to about 50° C., such as 0 to 40° C., more preferably within the range of from about 15° C. to about 30° C., and especially within the range of from about 17° C. to about 25° C., or above 15° C. to 17° C.

Preferably, the composition of the invention comprises at least 10% liquid, more preferably at least 25% liquid, and particularly preferably at least 50% liquid. Expressed differently, the preferred compositions according to the invention may be described as at least a waxy solid, more preferably a suspension, most preferably a liquid, especially a liquid of the eutectic composition.

In particularly preferred embodiments, the eutectic blend compositions of the present invention comprise ternary or quaternary combinations of biocides. Quinternary or higher combinations are also within the scope of the present invention. Preferably at least one of the biocides is a phenolic biocide.

In preferred embodiments of the present invention there is provided a blend consisting of at least three biocides wherein the eutectic blend is substantially in liquid form, preferably at least 60% in liquid form, more preferably at least 70% in liquid form, more preferably at least 80% in liquid form, more preferably at least 90% in liquid form and particularly preferably 100% in liquid form. Ideal blends of the invention have, or at least approach, a true eutectic composition.

Uses of the compositions of the present invention may include, but are not limited to, producing disinfectant formulations for hospitals or other medical institutions, veterinary surgeries and the like. For example, the biocide compositions of the present invention may be incorporated into formulations for disinfecting medical instruments, such as endoscopes. The compositions of the invention may also be used as ingredients for household cleaning and/or disinfectant formulations, and in the production of formulations for disinfecting food preparation services in industrial or domestic environments.

Where the composition of the present invention is to be used for formulating products for use in medical institutions and the like the composition, and the resulting formulation may desirably contain TRICLOSAN (5-chloro-2-(2,4-dichlorophenoxy)-phenol).

The total concentration of the biocides in a disinfectant formulation for use in medical environments such as hospitals may be greater than that for household disinfectants or cleaners. In formulations for medical use the total biocide concentration may, for example, be from 0.1 to 3%. In formulations for domestic use, the total biocide concentration may, for example, be from 0.1% to 2%., typically from 0.3% to 0.8%.

The composition of the present invention and formulations using such compositions may also be used for the impregnation of materials and textiles, such as paper, for example.

Cleaning and/or disinfectant formulations incorporating a composition according to the invention may also include a detergent. The detergent may in principle be selected from any of the well known detergent materials such anionic surfactants and cationic surfactants. Preferably, the detergent is selected from amongst the anionic surfactants.

Suitable anionic surfactants include salts (for example, sodium salts) of dodecylbenzenesulphonate, salts of laurylether sulphate, phosphate esters of nonylphenolethoxylates, nonylphenoxyphosphoric acid esters, or a combination thereof.

In other cleaning and/or disinfectant formulations incorporating biocide compositions of the invention, alcohol may be added. Suitable alcohols may include, for example, any water-soluble lower alkyl alcohol such as methanol, ethanol or propanol. Aromatic alcohols, such as benzyl, phenoxy- and dichlorobenzyl-alcohols may also be used.

In addition to the biocide compositions of the invention, cleaning, disinfectant and other formulations may include, for example, additives such as, emulsifying agents, fixing agents, stabilising agents, crystallisation inhibitors, pH buffering agents, diluting agents, colorants, fragrances, viscosity modifiers, water (or other aqueous solution), fillers, binders, lubricants, other natural or synthetic additives known in the formulation art, and mixtures thereof.

It is believed that the compositions of the present invention, and product formulations prepared using said compositions, ideally have a level of microbiological activity or efficacy which is at least as active as that of corresponding individual component biocides, and in ideal cases may be more active than the corresponding individual component biocides.

Biocides which are suitable for use in the compositions of the invention include: o-benzyl p-chlorophenol (BCP), p-tertiary amyl phenol (PTAP, 4-(1,1-dimethylpropyl)phenol), o-phenyl phenol (OPP, 2-phenylphenol), pentachlorophenol (PCP), hexachlorophenol (also know as hexachlorophene, 3,4,6-trichloro-2-[(2,3,5-trichloro-6-hydroxy-phenyl)methyl]phenol), bromophene (2,4-dibromo-6-(3,5-dibromo-2-hydroxy-phenyl)-phenol), TRICLOSAN, isothiazolinone (5-chloro-2-methyl-isothiazol-3-one, bromonitropropanediol, hexahydro-1 3,5-tris (hydroxyethyl)-s-triazine, sodium pyridine thiol-1-oxide, 3-iodo-2-propynyl butyl carbamate, methylene-bis-morpholine, benzisothiazolinone, n-octyl isothiazolinone, para chloro meta cresol (PCMC, 4-chloro-3-methyl-phenol), sodium salt of para chloro meta cresol (NaPC), para chloro meta xylenol ((PCMX), 4-Chloro-3,5-dimethylphenol)), dichloro meta xylenol (DCMX, 2,4-dichloro-3,5-dimethyl-phenol), sodium salt of ortho phenyl phenol (SOPP), sodium pyrithione, hexahydrotriazine, TRICHLOCARBAN (TCC, (4-chlorophenyl)amino-3,4-dichlorophenyl)amino-methanone), 2-(thiocyanomethylthio) benzothiazole, 1,3,5-triethylhexahydro-1,3,5-triazine, chlor-methyl isothiazolinones, 1,6-Dihydroxy-2,5-dioxahexane, 1,6-dihydroxy-2,5-dioxahexane, BRONOPOL (2-bromo-2-nitropropane-1,3-diol), NIPOCIDE FC (1,6-dihydroxy-2,5-dioxahexane) and sodium pyrithione.

The biocides, especially phenolic biocides, as mentioned hereinbefore and hereinafter may also be present in salt forms, for example alkali metal salt forms. An example of an alkali metal salt of a phenolic biocide is potassium or sodium o-phenylphenol.

The phenolic biocides as described herein may also be a mixture with other, non-phenolic biocides. In a preferred class of blends, all of the biocides present in the blend are phenolic biocides. In a preferred class of blends of the present invention, it is believed that the blend is at least as effective as a biocide as each of its individual components. In the compositions of the present invention, preferred binary combinations of biocides include OPP:NaPC, OPP:DCMX, OPP:BCP, OPP:PCMC, BCP:SOPP, BCP:NaPC, BCP:PCMC, SOPP:DCMX, SOPP:PCMC and SOPP:PTAP.

Binary combinations of the biocides according to the invention may include, but are not limited to, the ratios 19:1, 14:1, 9:1, 8:2, 7:3, 3:1, 3:2, 11:9, 1:1, 9:11, 4:6, 3:7, 2:8, 1:9, 1:14 and 1:19. Preferred ratios of biocides in the binary combinations include 8:2, 7:3, 3:1, 3:2, 11:9, 1:1, 9:11, 4:6, 3:7 and 2:8.

Below are non-limiting examples of some preferred binary systems:

OPP and NaPC in a ratio of 8:2 provided a pourable viscous liquid.

OPP and NaBCP in a ratio of 1:1 and 9:11 formed pourable liquids.

BCP and SOPP in a ratio of 4:6 produced a viscous liquid.

BCP and NaPC in a ratio of 8:2 produced a very viscous liquid.

SOPP and PCMC in a ratio of 3:7 produced a pourable liquid.

In the compositions of the present invention, preferred ternary combinations of biocides include BCP/OPP/PTAP, BCP/OPP/PCMX, BCP/OPP/DCMX, BCP/OPP/(1,6-dihydroxy-2,5-dioxahexane), BCP/PCMC/PTAP, BCP/PCMC/PCMX, BCP/PCMC/DCMX, BCP/PCMC/SOPP, BCP/PCMC/OPP, BCP/PCMC/NaPC, BCP/PCMC/TCC.

In the above compositions, BCP:OPP ratios may preferably include 1:1, 7:3 and 8:2. In the above compositions, BCP:PCMC ratios may preferably include 2:8. As the third component of the ternary compositions, the biocides PTAP, PCMX, DCMX, (1,6-dihydroxy-2,5-dioxahexane), SOPP, OPP, NaPC and TCC may preferably be added in an amount of up to 35 weight percent of the existing binary formulation.

Below are non-limiting examples of some preferred ternary systems.

Binary system BCP:OPP (1:1) with 1 to 20% PTAP incorporated therewith produced a liquid product.

Binary system BCP:OPP (1:1) with 1 to 5% PCMX incorporated therewith produced a liquid product.

Binary system BCP:OPP (1:1) with 10% DCMX incorporated therewith produced a liquid product.

Binary system BCP:OPP (1:1) with 20 to 30% NIPOCIDE FC incorporated therewith produced a liquid product.

Binary system BCP:OPP (7:3) with 1 to 20% PTAP incorporated therewith produced a liquid product.

Binary system BCP:OPP (7:3) with 1 to 10% PCMX incorporated therewith produced a liquid product.

Binary system BCP:OPP (7:3) with 1 to 10% DCMX incorporated therewith produced a liquid product.

Binary system BCP:OPP (7:3) with 1 to 30% 1,6-dihydroxy-2,5-dioxahexane incorporated therewith produced a liquid product.

Binary system BCP:OPP (8:2) with 1 to 10% PTAP incorporated therewith produced a liquid product.

Binary system BCP:OPP (8:2) with 5 to 10% PCMX incorporated therewith produced a liquid product.

Binary system BCP:OPP (8:2) with 10% DCMX incorporated therewith produced a liquid product.

Binary system BCP:OPP (8:2) with 5% 1,6-dihydroxy-2,5-dioxahexane incorporated therewith produced a liquid product.

Binary system BCP:PCMC (2:8) produced a liquid product with respective 5% of PTAP, PCMX, DCMX, SOPP, OPP and NaPC incorporated therewith.

Particularly preferred liquid ternary eutectic blends of the present invention, include o-benzyl p-chlorophenol being present in a total amount of not more than 66.5 wt %, preferably 30 to 60 wt-%, o-phenyl phenol being present in a total amount of at least 28 wt-%, preferably 28 to 54 wt-%, and p-tertiary amyl phenol being present in a total amount of at least 12 wt-%. Amounts of p-tertiary amyl phenol of greater than 12 wt-% provide increased stability of the resulting liquid formulation.

A further preferred ternary system is described in the Examples.

Examples of binary systems are shown below in Table 1 below. With reference to Table 1, the more preferred binary combinations are those which result in a liquid, crystal solution or soft/waxy solid. The presence of a waxy solid or crystalline solution indicates a pure substance plus a eutectic blend are likely to be present and may indicate that either a eutectic combination of the two substances may exist in an untested ratio of the component biocides, or that a composition having a room temperature melting point is achievable through the addition of a third biocide.

TABLE 1
BINARY BLENDS OF BIOCIDES

| | RATIO | | | | | | | | |
|---|---|---|---|---|---|---|---|---|---|
| Composition | 19:1 | 14:1 | 9:1 | 8:2 | 7:3 | 3:1 | 6:4 (3:2) | 11:9 | 1:1 |
| OPP & NaPC | | | Soft Solid | Viscous | Treacle | Treacle | Treacle | | Treacle |
| | | | | Pourable | like | like | like (hard) | | like |
| | | | | Liquid | | | | | (hard) |
| OPP & | Soft | Soft Solid | Soft Solid | Solid | Solid | | Slightly | | Damp |
| DCMX | Solid | | | | | | Damp | | Crystals |
| | | | | | | | Crystals | | |
| OPP & BCP | | | Damp | | Wet | | 90% | 50% | Liquid |
| | | | Crystals | | Crystals | | Crystal | Crystal | |
| | | | | | | | Solution | Solution | |
| OPP & PCMX | | Solid | Solid | | Solid | | | | Solid |
| OPP & | | Slightly | Waxy | Damp | Solid | | | | Solid |
| PCMC | | Damp | Crystals | Crystals | | | | | |
| | | Crystals | | | | | | | |
| BCP & SOPP | | Damp | Damp | Damp | Damp | Damp | Soft Solid | | Waxy |
| | | Crystals | Crystals | Crystals | Crystals | Crystals | | | Solid |
| BCP & NaPC | Treacle | Soft Solid | 60% | Treacle | Treacle | | | | Treacle |
| | like | | Crystal | like | like | | | | like |
| | (Hard) | | Solution | | | | | | (hard) |
| BCP & PCMC | | Solid | Waxy | Slightly | Waxy | | Slightly | | Waxy |
| | | | Solid | Damp | Solid | | Damp | | Solid |
| | | | | Crystals | | | Crystals | | |
| SOPP & | | | Solid | | Solid | | | | Solid |
| DCMX | | | | | | | | | |
| SOPP & | | | Solid | | Solid | | | | Solid |
| PCMX | | | | | | | | | |
| SOPP & | Solid | | Solid | | Waxy | | | | 95% |
| PCMC | | | | | Solid | | | | Crystal |
| | | | | | | | | | Solution |
| OPP & PTAP | | Hard | Waxy | Solid | Solid | | | | Solid |
| | | Slightly | Solid | | | | | | |
| | | Damp | | | | | | | |
| | | Solid | | | | | | | |
| BCP & PTAP | | Solid | Waxy | Solid | Waxy | | Solid | | Waxy |
| | | | Solid | | Solid | | | | Solid |
| PCMC & | | Slightly | Solid | | Solid | | | | Solid |
| PTAP | | Waxy | | | | | | | |
| | | Solid | | | | | | | |
| SOPP & | | Solid | Solid | | Waxy | | | | Damp |
| PTAP | | | | | Solid | | | | Crystals |

| | RATIO | | | | | | |
|---|---|---|---|---|---|---|---|
| Composition | 9:11 | 4:6 | 3:7 | 2:8 | 1:9 | 1:14 | 1:19 |
| OPP & NaPC | | | | | Solid | | |
| OPP & | | Solid | | | Solid | | |
| DCMX | | | | | | | |
| OPP & BCP | Liquid | 95% | Wet | Wet | Wet | | |
| | | Crystal | Crystals | Crystals | Crystals | | |
| | | Solution | | | | | |
| OPP & PCMX | | | | | Solid | | |
| OPP & | | | Solid | 95% | 95% | 99% | Damp |
| PCMC | | | | Crystal | Crystal | Crystal | Crystal |
| | | | | Solution - | Solution - | Solution - | |
| | | | | Damp | Damp | Damp | |
| | | | | Crystals | Crystals | Crystal | |
| BCP & SOPP | | Viscous | Waxy | | Solid | | |
| | | Hazy | Solid | | | | |
| | | Liquid | | | | | |
| | | Waxy Solid | | | | | |
| BCP & NaPC | | | | | | | |
| BCP & PCMC | | Slightly | Slightly | Waxy Solid | Solid | | Solid |
| | | Damp | Damp | | | | |
| | | Crystals - | Crystals | | | | |
| | | Soft Solid | | | | | |
| SOPP & | | Solid | Soft Solid | Solid | Solid | | |
| DCMX | | | | | | | |
| SOPP & | | | Solid | | Solid | | |
| PCMX | | | | | | | |
| SOPP & | | Opaque | Liquid | 50% | Waxy Solid | | Waxy |
| PCMC | | Liquid - | | Crystal | | | Solid |
| | | Damp | | Solution - | | | |
| | | Solid | | Damp | | | |
| | | | | Crystals | | | |
| OPP & PTAP | | | Solid | | Waxy Solid | Solid | |
| BCP & PTAP | | | Solid | | Waxy Solid | Solid | |
| PCMC & | | | Solid | | Solid | Solid | |
| PTAP | | | | | | | |
| SOPP & | | | Waxy | | Solid | Solid | |
| PTAP | | | Solid | | | | |

Examples of ternary systems are shown in Table 2 below.

With reference to the ternary systems shown in Table 2, it can be seen that these systems tend more readily to form liquid eutectic mixtures at room temperature. In particular, liquids were formed upon addition of a third biocide to binary blends in the form of a crystalline solution or a waxy solid.

Comparing the binary systems of Table 1 with the ternary systems of Table 2, it is clear that a third biocide can significantly lower the melting point of the mixture to provide a liquid where the binary system is not wholly liquid. For example, comparing BCP:OPP binary mixture, at the ratio 8:2, the binary system is defined as wet crystals. However, upon addition of 1% PTAP, a liquid is generated. By analogy, it can be expected that ternary combinations are can be more likely to form, crystal solutions and suspensions where a binary composition to which a third biocide is to be added is in the form of a solid or waxy solid, for example.

It is contemplated that a ternary system may be formulated by adding a third biocide to an existing binary system. For example, a ternary system may consist of approximately 99 to 70% of a binary blend and 1 to 30% of a third biocide, e.g. 85% of a binary substance and 15% of a third biocide.

TABLE 2
TERNARY BIOCIDE MIXTURES

| Binary | | | | | | | | | |
|---|---|---|---|---|---|---|---|---|---|
| Composition | Added Tertiary Component | | | | | | | | |
| and Ratio | Amount | PTAP | PCMX | DCMX | NIPOCIDE FC | SOPP | OPP | NaPC | TCC |
| BCP to OPP | | | | | | | | | |
| 1 to 1 | 1% | Liquid | Liquid | | | | | | |
| (liquid) | 5% | Liquid | Liquid | | | | | | |
| | 10% | Liquid | X | | | | | | |
| | 20% | Liquid | | | | | | | |
| | 30% | X | X | X | Liquid | | | | |
| 7 to 3 | 1% | Liquid | Liquid | Liquid | Liquid | | | | |
| (Wet | 5% | Liquid | Liquid | Liquid | Liquid | | | | |
| Crystals) | 10% | Liquid | Liquid | Liquid | Liquid | | | | |
| | 20% | Liquid | X | X | Liquid | | | | |
| | 30% | X | X | X | Liquid | | | | |
| 8 to 2 | 1% | Liquid | | | | | | | |
| (Wet | 5% | Liquid | Liquid | | Liquid | | | | |
| Crystals) | 10% | Liquid | Liquid | Liquid | X | | | | |
| | 20% | X | X | | X | | | | |
| | 30% | X | X | X | X | | | | |
| BCP to | | | | | | | | | |
| PCMC | | | | | | | | | |
| 2 to 8 | 5% | Liquid | Liquid | Liquid | | Liquid | Liquid | Liquid | Waxy |
| (Waxy | | | | | | | | | Solid |
| Solid) | | | | | | | | | |

Key:
X Not Liquid: crystal solutions or soft solids not confirmed

In one embodiment, the incorporation level of the third biocide may be dependent upon its solubility in the two components of the initial binary system and therefore, in some ternary systems, the third biocide will not normally form a major constituent of any ternary system.

However, the amounts of particular phenolic biocides which may be included in ternary or greater mixtures in the compositions of the invention are not limited, provided that the resulting compositions have properties that are damp blends or liquid blends or liquid crystal bends as defined above rather than the solid form of the respective individual biocide components at the temperatures of use and storage. Whether a particular composition exists in liquid form at room temperature, or at a temperature below room temperature, can be determined by simple experiment by one skilled in the art.

The compositions according to the invention can be prepared by dry-mixing the component biocides, heating the mixture until molten and allowing the mixture to cool. It was discovered that the eutectic blends of the present invention wherein biocide compounds have different melting points, that biocide compounds can be combined at a blending temperature which is equal to or above the melting point of the component having the lowest melting point and lower than melting point of the component having the highest melting point. Thus, by the selective combination of components in order of increasing melting points, eutectic blends can be produced at blending temperatures which are significantly lower than the melting point of the component having the highest melting point. In this manner, the risk of degradation of the lower melting point biocide component is minimized.

However, it is preferred to heat a quantity of a single biocide until molten and then to add the remaining biocide(s) in order of increasing melting point with stirring until a complete melt is again achieved with no remaining solids. The melt is then allowed to cool to achieve the desired biocide composition. The temperature to which the phenolic biocides must be heated in order to obtain a melt is not usually very high and temperatures of 80° C. or below, such as 50° C., will normally be adequate.

In one method of preparing the biocides of the present invention, the temperature for combining each component biocide with one another may be stepped. To this end, a first biocide may be heated to about 40 to 60° C. and a second biocide may be added. At this temperature the second biocide may dissolve in the first biocide. A second temperature level may then be achieved by raising the temperature by 0 to 15° C. At this point, a third biocide may be added. The temperature may then be raised a further 0 to 10° C. to dissolve the mixture to create a uniform liquid blend.

A typical top temperature for forming a ternary liquid blend is 60 to 80° C., for example 65 to 70° C.

In addition, experimentation by cold temperature storage has indicated that the 1:1 ratio of, for example, BCP:OPP provides optimum results. Furthermore, 20% PTAP can be added to this binary system without solidification of the liquid mixture.

### EXAMPLE 1

A melt comprising BCP (70%) and OPP (30%) was prepared. To this was added PTAP in the ratio melt: PTAP 95:5. The mixture was stirred until no solids remained and then allowed to cool. The resulting composition was a liquid stable at room temperature. The composition also remained in stable liquid form at 0° C.

### EXAMPLE 2

An exemplary blend, as described in the table below, was prepared, as described in the method shown in Table 3 below.

TABLE 3
TERNARY BLEND

| | | | Adjusted | | |
|---|---|---|---|---|---|
| | Amount | | Amount | Actual | |
| Ingredient | per 100 g | % Active | per 100 g | Amount | Ratio |
| NIPACIDE | 38 | 97.2 | 40 | 59 | 2.5 |
| BCP | | | | | |
| NIPACIDE | 15 | 99.6 | 15 | 23 | 1 |
| PTAP | | | | | |
| NIPACIDE | 46 | 99.5 | 46 | 70 | 3 |
| OPP | | | | | |

Method of Blending

Preparation

Prior to starting the blend, all products were ground with a mortar and pestle so that they were fine powders. This facilitated weighing the samples and shortened the amount of time necessary for melting/blending, which was important considering the small volume that was being made. NIPACIDE PTAP was critical to grind considering the pellet size of the commercial product.

Mixing

The biocides were added in ascending order of their melting points. BCP (46° C.), OPP (57° C.), PTAP (95° C.). 59 g of powdered BCP was weighted into a clean 250 mL beaker and placed on a magnetic hot plate. Slowly the temperature was increased to approximately 50 to 55° C. and held until all the BCP was completely melted. The metal tip of the thermometer was used to stir the powdered BCP until it was melted. A magnetic stir bar was added to the beaker to facilitate mixing at this time.

70 g of powdered OPP was weighed into a plastic weighing boat. Portions were added to the melted BCP and allowed to melt. The OPP was not added all at once to minimize the amount sticking to the sides of the beaker and to make sure that the beaker did not over flow. As the OPP was added the temperature of the mixture was raised to approximately 55 to 60° C. and held until all of the OPP was added and was completely melted.

23 g of powdered PTAP was weighed into a plastic weighing boat. Portions were added to the melted solution and allowed to melt. As the PTAP was added the temperature of the mixture was raised to approximately 65 to 70° C. and held until all of the PTAP was added and completely melted. From start to finish this process took about 15 to 20 minutes to complete. After all phenolics were added and all ingredients were dissolved, the blend was transferred to a clean screw cap jar and allowed to cool to room temperature over night.

When cool the blend is a deep amber colour and is viscous but flowing.

### EXAMPLE 3

The following samples were tested to observe their physical properties at freezing temperatures:

| Blends Tested | | Ratio |
|---|---|---|
| Blend No. 1: | 45 g BCP + 45 g OPP | (1:1) |
| Blend No. 2: | 55 g BCP + 45 g OPP | (1.2:1) |
| Blend No. 3: | 45 g BCP + 45 g OPP + 20 g PTAP | (2.25:2.25:1) |
| Blend No. 4: | 56 g BCP + 24 g OPP + 20 g PTAP | (2.8:1.2:1) |
| Blend No. 5: | 72 g BCP + 18 g OPP + 10 g PTAP | (7.2:1.8:1) |
| Blend No. 6: | 72 g BCP + 18 g OPP + 10 g PCMX | (7.2:1.8:1) |
| Blend No. 6A: | 40 g BCP + 46 g OPP + 15 g PTAP | (2.5:3:1) |

After blending, such as by the method above, for example, all samples were allowed to cool to room temperature (20° C.). All samples stayed liquid at room temperature, except for blend 5. Blend 5 was placed at a temperature of between 30-35° C., and it completely returned to liquid.

Overnight Freezing

All samples were placed in a freezer overnight (23° C.).

The BCP Sample was frozen solid, and appeared whitish in color with crystals, and had an uneven surface

Blend No. 1 was very viscous. When a probe was applied, depressions formed. After a period of time less than 5 minutes, the depressions disappeared.

Blend No. 2 was same as Blend No. 1 with some areas that appeared ready to crystallize.

Blend No. 3 was very viscous. When a probe was applied, depressions formed. After a period of time less than 5 minutes, the depressions disappeared.

Blend No. 4 was very viscous. When probe was applied, depressions formed. After a period of time less than 5 minutes, the depressions disappeared.

Blend No. 5 had a liquid portion is similar to Blend No. 1 with additional large frozen sections that had the appearance of the BCP Sample.

Blend No. 6 appeared same as Blend No. 5, but with fewer frozen sections.

Extended Freezing

All samples were placed back in the same freezer at the same temperature for an additional 2 days. In the BCP sample, there was-no change. Blends 1,2,3, and 4 showed some areas starting to crystallize on top. Blends 5 and 6 remained mostly frozen, resembling the BCP sample.

Thawing

All samples were left at room temperature to thaw overnight. Blends 1,2,3, and 4 all returned to liquid at room temperature. Blends 5,6 returned to liquid, but containing crystals.

### EXAMPLE 4

The viscosities of the following blends were tested:

Blends Tested

| | |
|---|---|
| Blend No. 1: | 45 g BCP + 45 g OPP |
| Blend No. 2: | 55 g BCP + 45 g OPP |
| Blend No. 3: | 45 g BCP + 45 g OPP + 20 g PTAP |
| Blend No. 4: | 56 g BCP + 24 g OPP + 20 g PTAP |
| Blend No. 5: | 72 g BCP + 18 g OPP + 10 g PTAP |
| Blend No. 6: | 72 g BCP + 18 g OPP + 10 g PCMX |
| Blend No. 6A: | 40 g BCP + 46 g OPP + 15 PTAP |

Viscosity Method

The procedure used a Brookfield viscometer.

The apparatus used was a Brookfield viscometer, Programmable DV-II+Viscometer and a SC4-18 spindle.

The samples were tested at 100 rpm and at a range of temperatures, as shown in Table 4—Viscosity Measurement Results below.

All measurements were made in centipoise. For reference purposes, the viscosity of water, at 25° C. is 0.89 centipoise, and the viscosity of ethylene glycol at 25° C. is about 16 centipoise.

TABLE 4
VISCOSITY MEASUREMENTS RESULTS

| | |
|---|---|
| Sample | Temperatures (° C.) |

| Number | 10 | 20 | 25 | 40 |
|---|---|---|---|---|
| 1 | 210.0 | 148.5 | 86.7 | 28.7 |
| 2 | Crystalline | 148.5 | 87.0 | 34.1 |
| 3 | Crystalline | 134.4 | 94.2 | 32.1 |
| 4 | 178.8 | 151.5 | 95.1 | 31.8 |
| 5 | Crystalline | 144.9 | Crystalline | 31.5 |
| 6 | Crystalline | Crystalline | 1138 | 28.8 |
| BCP | Crystalline | — | — | 29.4 |
| 6A | 169.7 | 136.2 | 97.2 | 33.6 |

### EXAMPLE 5

The following additional samples 7-20 were prepared as shown in Table 5:

TABLE 5
Additional Samples Prepared

| SAMPLE | OPP | BCP | PTAP | Ratio: | Observed |
|---|---|---|---|---|---|
| 7 | 33.2 | 49.8 | 16.6 | 2:3:1 | Liq. |
| 8 | 33.7 | 48.2 | 18.1 | 5.6:8:3 | Liq. |
| 9 | 28.6 | 57.2 | 14.3 | 2:4:1 | Liq. |
| 10 | 54 | 27 | 18.9 | 2:1:0.7 | Liq. |
| 11 | 40 | 48 | 12 | 5:6:1.5 | Liq. |
| 12 | 55 | 45 | — | 11:9 | Sol. |
| 13 | 66.6 | 33.3 | — | 2:1 | Slush. |
| 14 | 60 | 40 | — | 3:2 | Sol. |
| 15 | 40 | 60 | — | 2:3 | Liq. |
| 16 | 20 | 65 | 15 | 1.3:4.3:1 | Sol. |
| 17 | 20 | 54 | 26 | 1:2.7:1.3 | Sol. |
| 18 | 7.4 | 85.2 | 7.4 | 1:11.5:1 | Sol. |
| 19 | 26 | 66.6 | 7.4 | 3.5:9:1 | Sol. |
| 20 | 77.8 | 11.1 | 11.1 | 7:1:1 | Sol. |

As in Example 3, all samples were combined in ascending order of increasing melting point by weighing and melting the BCP and after the BCP was melted, the weighed portion of the OPP was blended to the molten BCP. The temperature of the blend of BCP and OPP was heated to effectively melt the mixture before adding the PTAP. The PTAP was added to the BCP and OPP mixture with continued heating. At no time during the above melting/blending procedure did the temperature of the mixture exceed 60° C. Those samples shown in the above table observed to remain liquid after allowing the mixtures to return to room temperature and remain undisturbed for about 48 hours were labelled as “Liq.” Samples 13 and 14 immediately recrystalized or became solid (Sol.). Sample 12 recrystalized within a few days, but upon shaking was observed to be a stable slushy liquid.

The viscosities of the additional samples which were observed to remain stable liquids are shown in Table 6—Viscosity Measurements, below:

TABLE 6
Viscosity Measurements

| Sample: | 20° C. | 25° C. | 40° C. |
|---|---|---|---|
| 7 | 133.8 | 90.6 | 26.8 |
| 8 | 129.0 | 91.7 | 26.5 |
| 9 | 126.7 | 90.8 | 28.7 |
| 10 | 124.6 | 90.6 | 25.1 |
| 11 | 138.1 | 87.3 | 27.1 |
| 15 | 127.5 | 90.3 | 27.1 |

Liquid Samples 7, 8, 9, 10, and 11 were placed in a freezer (−23° C.) for a period of about 48 hours and observed. Samples 7, 8, 9, and 11 were found to be very viscous, but pourable and there were no crystals visible in the liquid. Sample 10 was also very viscous and pourable, but small amounts of two types of crystals were present.

The observed crystals in Sample 10 were not apparent when Sample 10 was returned to room temperature.

### EXAMPLE 7

The samples which were previously observed to be solid or non-liquid were liquefied by melting or heating until the sample was completely and portions of ethanol were added to the sample in an amount up to 5 wt-% which was effective to provide an all liquid eutectic blend at room temperature. The following Table 7—Effective Amount of Alcohol to Provide Stable Eutectic Blends presents the results.

TABLE 7
Effective Amount of Alcohol to Provide Stable
Eutectic Blends

| SAMPLE | %-wt Ethanol added to Sample |
|---|---|
| 3 | 1 |
| 4 | 1 |
| 5 | 1 |
| 6 | 1 |
| 12 | 1 |
| 13 | >5 with some crystals |
| 14 | 3 |
| 15 | 1 |
| 16 | >5 with some crystals |
| 17 | 2 |
| 18 | >5 with some crystals |
| 19 | >5 with some crystals |
| 20 | 2 |

It was observed in all cases that when up to about 5 wt-% ethanol was added to the previously solid or mostly solid sample blends, that all of the resulting blends were pourable and stable at room temperature. Those few sample blends 13, 16, 18, and 19 appeared to have some crystal formation, but they were mostly liquid at room temperature and observed to be stable over a period of about 48 hours.

### EXAMPLE 8

The compositions represented by Samples 1-20 were plotted on triangular coordinates wherein each of the axes of the triangle represented from 0 to 1.00 weight fraction of each component in the blend or mixture. The triangular plot is presented as FIG. 2. Referring to FIG. 2, the composition of BCP is presented on the bottom axis, the composition of OPP is shown on the left-hand axis, and the composition of PTAP is shown on the right-hand axis. Three areas are defined by the binary and ternary compositions of Samples 1-20. Compositions encompassed by the area labelled C were solid between the temperatures of about 10° C. and about 40° C. Compositions encompassed by area A were liquid between the temperatures of about 10° C. and about 40° C. Compositions between the areas A and C, marked B were observed to be eutectic blends of the three components which are stable and pourable, yet may contain some degree of crystal formation.

### EXAMPLE 9

The following concentrate was made:

| | Percentage | |
|---|---|---|
| Ingredient | Weight | Description of function |
| BCP | 10.1% | Active Ingredient |
| OPP | 4.9% | Active Ingredient |
| PTAP | 2.5% | Active Ingredient |
| DOWFAX 2AI | 20.0% | Detergent |
| IPA | 6.25% | Solvent |
| Na-EDTA | 1.0% | Chelating Agent |
| NaOH | 2.3% | Solubilizer |
| water | 52.82% | solvent |
| perfume | 0.13% | perfume |

The product of Example 9 may be added to water as a dilution in use.

### EXAMPLE 10

The following concentrate was made:

| | Percentage | |
|---|---|---|
| Ingredient | Weight | Description of function |
| BCP | 5.0% | Active Ingredient |
| OPP | 4.25% | Active Ingredient |
| PTAP | 1.25% | Active Ingredient |
| IPA | 19.94% | Solvent |
| ULTRAWT KX | 7.0% | Detergent |
| SXS 40 | 9.0% | Detergent |
| DOWFAX 282 | 2.0% | Detergent |
| Na-EDTA | 3.0% | Chelating Agent |
| Sodium Sulfite | 0.5% | Colour stabilizer |
| Water | 48.06% | solvent |

The biocide solution of Example 10 may be used in, e.g. hospitals as a disinfection cleaner formulation. It may be further diluted with water in use.

| Trade Name | Company | Description |
|---|---|---|
| TRICLOSAN | CIBA | (5-chloro-2-(2,4- |
| | | dichlorophenoxy)-phenol) |
| Bronopol | | 2-bromo-2-nitropropane-1,3- |
| | | diol |
| NIPOCIDE FC | Clariant GmbH | 1,6-dihydroxy-2,5- |
| | | dioxahexane |
| NIPACIDE BCP | Clariant Corp. | o-benzyl p-chlorophenol |
| NIPACIDE PTAP | Clariant Corp. | p-tertiary amyl phenol (4- |
| | | (1,1-dimethylpropyl)phenol) |
| NIPACIDE OPP | Clariant Corp. | o-phenyl phenol (2- |
| | | phenylphenol) |
| ULTRAWET KX | Arco Chemical | Sodium dodecylbenzene |
| | Co. | sulfonate |
| SXS 40 | Clariant Corp. | Sodium xylene sulfonate |
| TRICHLOCARBAN | Clariant Corp. | (4-chlorophenyl)amino-(3,4- |
| | | dichlorophenyl)amino- |
| | | methanone), 2- |
| | | (thiocyanomethylthio) |
| | | benzothiazole |
| DOWFAX 282 | Dow Chemical | |
| DOWFAX 2AI | Dow Chemical | dodecyldiphenyl oxide |
| | | disulfonic acid |

1. A composition consisting essentially of a mixture of two or more biocides and not more than 5% in total of formulating additives wherein the composition is in the form of a eutectic blend at a temperature within the range of −25° C. to 50° C.

2. The composition of claim 1, wherein the temperature ranges from 0 to 50° C.

3. The composition of claim 1, wherein the composition consists of at least three biocides.

4. The composition of claim 1, wherein at least one of the biocides is a phenolic biocide.

5. The composition of claim 1, wherein each of the two or more biocides is a phenolic biocide.

6. The composition of claim 1, wherein the two or more biocides are selected from the group consisting of o-benzyl p-chlorophenol (BCP), p-tertiary amyl phenol (PTAP, 4-(1,1-dimethylpropyl)phenol), o-phenyl phenol (OPP, 2-phenylphenol), pentachlorophenol (PCP), hexachlorophenol (3,4,6-trichloro-2-[(2,3,5-trichloro-6-hydroxy-phenyl)methyl]phenol, bromophene (2,4-dibromo-6-(3,5-dibromo-2-hydroxy-phenyl)-phenol), 5-chloro-2-(2,4-dichlorophenoxy)-phenol, isothiazolinone (5-chloro-2-methyl-isothiazol-3-one, bromonitropropanediol, hexahydro-1 3,5-tris (hydroxyethyl)-s-triazine, sodium pyridine thiol-1-oxide, 3-iodo-2-propynyl butyl carbamate, methylene-bis-morpholine, benzisothiazolinone, n-octyl isothiazolinone, para chloro meta cresol (PCMC, 4-chloro-3-methyl-phenol), sodium salt of para chloro meta cresol (NaPC), para chloro meta xylenol ((PCMX), 4-Chloro-3,5-dimethylphenol)), dichloro meta xylenol (DCMX, 2,4-dichloro-3,5-dimethylphenol), sodium salt of ortho phenyl phenol (SOPP), sodium pyrithione, hexahydrotriazine, (4-chlorophenyl)amino-(3,4-dichlorophenyl)amino-methanone), 2-(thiocyanomethylthio) benzothiazole, 1,3,5-triethylhexahydro-1,3,5-triazine, chlor-methyl isothiazolinones, (1,6-dihydroxy-2.5-dioxahexane), (2-bromo-2-nitropropane-1,3-diol), sodium pyrithione, and mixtures thereof.

7. The composition of claim 1, wherein the formulating additives are selected from the group consisting of water, alcohol, a colorant, a fragrance, a viscosity modifier, a surfactant, a solvent, and mixtures thereof.

8. The composition of claim 1, wherein the eutectic blend consists of a liquid component consisting of a biocide mixture and at least one solid component consisting of one or more biocides.

9. The composition of claim 8 in the form of a suspension.

10. The composition of claim 1, wherein the two or more biocides are selected from the group consisting of o-benzyl p-chlorophenol, p-tertiary amyl phenol and o-phenyl phenol.

11. The composition of claim 1, wherein the mixture is a liquid consisting of o-benzyl p-chlorophenol (BCP) o-phenyl phenol (OPP), and p-tertiary amyl phenol (PTAP), wherein a ratio of BCP:OPP is 1:1 and PTAP ranges from about 1 to 20 weight percent of the liquid.

12. The composition of claim 1, wherein the mixture is a liquid consisting of o-benzyl p-chlorophenol (BCP), o-phenyl phenol (OPP), and para chloro meta xylenol (PCMX), wherein a ratio of BCP:OPP is 1:1 and PCMX ranges from about 1 to 5 weight percent of the liquid.

13. The composition of claim 1, wherein the mixture is a liquid consisting of o-benzyl p-chlorophenol (BCP), o-phenyl phenol (OPP), and dichloro meta xylenol (DCMX), wherein a ratio of BCP:OPP is 1:1 and DCMX is about 10 weight percent of the liquid.

14. The composition of claim 1, wherein the mixture is a liquid consisting of o-benzyl p-chlorophenol (BCP), o-phenyl phenol (OPP), and 1,6-dihydroxy-2,5-dioxahexane, wherein a ratio of BCP:OPP is 1:1 and 1,6-dihydroxy-2,5-dioxahexane ranges from about 20 to 30 weight percent of the liquid.

15. The composition of claim 1, wherein the mixture is a liquid consisting of o-benzyl p-chlorophenol (BCP), o-phenyl phenol (OPP), and p-tertary amyl phenol (PTAP), wherein a ratio of BCP:OPP is 7:3 and PTAP ranges from about 1 to 20 weight percent of the liquid.

16. The composition of claim 1, wherein the mixture is a liquid consisting of o-benzyl p-chlorophenol (BCP), o-phenyl phenol (OPP), and para chloro meta xylenol (PCMX), wherein a ratio of BCP:OPP is 7:3 and PCMX ranges from about 1 to 10 weight percent of the liquid.

17. The composition of claim 1, wherein the mixture is a liquid consisting of o-benzyl p-chlorophenol (BCP), o-phenyl phenol (OPP), and dichloro meta xylenol (DCMX), wherein a ratio of BCP:OPP is 7:3 and DCMX ranges from about 1 to about 10 weight percent of the liquid.

18. The composition of claim 1, wherein the mixture is a liquid consisting of o-benzyl p-chlorophenol (BCP), o-phenyl phenol (OPP), and 1,6-dihydroxy-2,5-dioxahexane, wherein a ratio of BCP:OPP is 7:3 and 1,6-dihydroxy-2,5-dioxahexane ranges from about 1 to about 30 weight percent of the liquid.

19. The composition of claim 1, wherein the mixture is a liquid consisting of o-benzyl p-chlorophenol (BCP), o-phenyl phenol (OPP), and p-tertary amyl phenol (PTAP), wherein a ratio of BCP:OPP is 8:2 and PTAP ranges from about 1 to 10 weight percent of the liquid.

20. The composition of claim 1, wherein the mixture is a liquid consisting of o-benzyl p-chlorophenol (BCP), o-phenyl phenol (OPP), and para chloro meta xylenol (PCMX), wherein a ratio of BCP:OPP is 8:2 and PCMX ranges from about 5 to 10 weight percent of the liquid.

21. The composition of claim 1, wherein the mixture is a liquid consisting of o-benzyl p-chlorophenol (BCP), o-phenyl phenol (OPP), and dichloro meta xylenol (DCMX), wherein a ratio of BCP:OPP is 8:2 and DCMX ranges from about 1 to about 10 weight percent of the liquid.

22. The composition of claim 1, wherein the mixture is a liquid consisting of o-benzyl p-chlorophenol (BCP), o-phenyl phenol (OPP), and 1,6-dihydroxy-2,5-dioxahexane, wherein a ratio of BCP:OPP is 8:2 and 1,6-dihydroxy-2,5-dioxahexane is about 5 weight percent of the liquid.

23. The composition of claim 1, wherein the mixture is a liquid consisting of o-benzyl p-chloro phenol (BCP), para chloro meta cresol (PCMC), and a third biocide component selected from the group consisting of p-tertary amyl phenol (PTAP), para chloro meta xylenol (PCMX), dichloro meta xylenol (DCMX), sodium salt of ortho phenyl phenol (SOPP), o-phenyl phenol (OPP), and sodium salt of para chloro meta cresol (NaPC), wherein a ratio of BCP:PCMC is 2:8 and the third biocide component is about 5 weight percent of the liquid.

24. A liquid eutectic biocide composition consisting essentially of
a) 30 to 60 wt-% BCP
b) at least 28 wt-% OPP,
c) at least 12 wt-% PTAP, and
d) less than 5 wt-% of at least one formulating additive selected from the group consisting of water, alcohol, colourants, fragrances, viscosity modifiers, surfactants, solvents, and mixtures thereof.

25. The liquid eutectic biocide composition of claim 11, wherein the at least one formulating additive is less than 2 wt-% of said composition.

26. The liquid eutectic biocide composition of claim 11, wherein the at least one formulating addition is alcohol in an amount of from 0 to 2 wt-% of said composition.

27. A method for preparing a liquid eutectic biocide composition comprising at least two biocide compounds, said method comprising combining said at least two biocide compounds in ascending order of melting points.

28. The composition of claim 1, wherein the composition is a eutectic liquid blend wherein the at least two biocide compounds are BCP, OPP and PTAP being present in said composition according to a range of weight fractions according to area A in FIG. 1.

29. The composition of claim 1, wherein the composition is a damp blend wherein the at least two biocide compounds are BCP, OPP and PTAP being present in said composition according to a range of weight fractions according to area B in FIG. 1.

30. The composition of claim 1, wherein the composition is a liquid and the at least two biocide compounds are OPP and NaPC in a ratio of 8:2 on a weight basis.

31. The composition of claim 1, wherein the composition is a liquid and the at least two biocide compounds are OPP and NaBCP in a ratio of 1:1 or 9:11 on a weight basis.

32. The composition of claim 1, wherein the composition is a liquid and the at least two biocide compounds are BCP and SOPP in a ratio of 4:6 on a weight basis.

33. The composition of claim 1, wherein the composition is a liquid and the at least two biocide compounds are SOPP and PCMC in a ratio of 3:7 on a weight basis.

34. The composition of claim 1, wherein the composition is a liquid and the at least two biocide compounds are a ternary combination of biocides selected from the group consisting of BCP/OPP/PTAP, BCP/OPP/PCMX, BCP/OPP/DCMX, BCP/OPP/(1,6-dihydroxy-2,5-dioxahexane), BCP/PCMC/PTAP, BCP/PCMC/PCMX, BCP/PCMC/DCMX, BCP/PCMC/SOPP, BCP/PCMC/OPP, BCP/PCMC/NaPC, and BCP/PCMC/TCC.

35. A composition consisting of a mixture of two or more biocides and not more than 5% in total of formulating additives wherein the composition is in the form of a eutectic blend at a temperature within the range of −25° C. to 50° C.

36. A liquid eutectic biocide composition consisting of
e) 30 to 60 wt-% BOP
f) at least 28 wt-% OPP
g) at least 12 wt-% PTAP,and
less than 5 wt-% of at least one formulating additive selected from the group consisting of water; alcohol, colourants, fragrances, viscosity modifiers, surfactants, solvents, and mixtures thereof
